(19) United States
(12) Patent Application Publication
(10) Pub. No.: US 2020/0409416 A1
(43) Pub. Date: Dec. 31, 2020

(54) FLEXIBLE POINT OF SALE DEVICE

(71) Applicant: NCR Corporation, Atlanta, GA (US)

(72) Inventor: Rafael Yepez, Duluth, GA (US)

(21) Appl. No.: 16/455,230

(22) Filed: Jun. 27, 2019

(51) Int. Cl. G06F 1/16; G06Q 20/20

(52) U.S. Cl. CPC G06F 1/1652; G06F 1/1643; G06F 1/1641; G06Q 20/204

(57) ABSTRACT

Disclosed are flexible point of sale devices and methods for controlling the same. The systems and methods may include a body that houses electronics and a flexible display screen affixed to the body. During use, the body and the flexible display screen may be bent into various configurations. In addition, during use, various user interfaces may be displayed on different parts of the flexible display for use by one or more users.

### SUMMARY

Disclosed are flexible point of sale devices and methods for controlling the same. The systems and methods may include a body and a flexible display screen. The body may have a first ridged portion, a second ridged portion, and a flexible portion located in between the first ridged portion and the second ridged portion. The flexible display screen may be connected to the body and may span the first ridged portion, the flexible portion, and the second ridged portion.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIGS. 1A-1D show an example point of sale device consistent with embodiments disclosed herein.

FIGS. 2A and 2B show an example point of sale device consistent with embodiments disclosed herein.

FIGS. 3A and 3B show an example point of sale device consistent with embodiments disclosed herein.

FIG. 4 shows an example schematic of a point of sale device consistent with embodiments disclosed herein.

FIG. 5 shows an example method consistent with embodiments disclosed herein.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit this disclosure. Instead, the proper scope of any invention disclosed herein is defined by the appended claims.

Disclosed herein are point of sale (POS) devices and methods for operating the point of sale devices. The POS devices may include a body and a display screen that are both flexible. As a result, the POS device may be folded or otherwise have one portion that is repositionable relative to another portion of the POS device.

The flexible form factor of the POS devices disclosed herein may allow for a user interface that can become two separate interactive areas of the user interface when in a folded state or a single user interface when in an unfolded state. For example, when the POS devices are in a folded state, the POS devices may become a desktop POS and display two opposing interactive areas. One of the interactive areas may be for the store associate's use and the other interactive area may be for the customer's use during a transaction when in “assisted mode,” or the associate's interactive area maybe disabled when in a “non-assisted” self-check-out mode.

The POS devices may be used in a tablet mode for “queue busting” or processing transactions around the store. Sensors, such as accelerometers, may transmit signals that may disable the bottom interactive area for the top one to be used as a tablet only. Hence, the user interface and experience provide by the POS devices is dynamic as it adapts to whichever position, rotation, orientation, etc. the POS device is in. This is different than static displays which have fixed user interfaces that are either portrait or landscape or tablets which are a single UI that can rotate the user interface in one axis.

The POS devices disclosed herein may include digital SIM capability for cloud access and mobility. The screens used for the POS devices may include pressure sensitive multi-touch screens. Sensors used in the POS devices may include one or more accelerometers. For example, one accelerometer may be used for each side of the POS devices. The accelerometers may be used to detect folding or rotating positions and adapt the user interface accordingly.

The POS devices may also include embedded near field communications (NFC) reader for mobile payment or loyalty rewards membership authentication. A camera to process biometrics such as face or palm identification for payments or to take shelves inventory etc. The POS devices may also include embedded RFID antenna around the perimeter for RFID tag detection while processing a transaction or for taking store inventory.

Still consistent with embodiments disclosed herein, the POS devices may include two actual separate touch screen displays could be fitted onto the device on each side of a hinge versus one larger flexible touch screen display.

The POS devices disclosed herein may also include a docking station. The docking station may include ports that can be used to provide power for operating and charging batteries of the POS devices. The docking station may also include ports that may allow for expanding of the POS devices connectivity with hardware peripherals such as printers, desktop barcode scanners, produce scale, cash drawer connection or other retail or hospitality required devices.

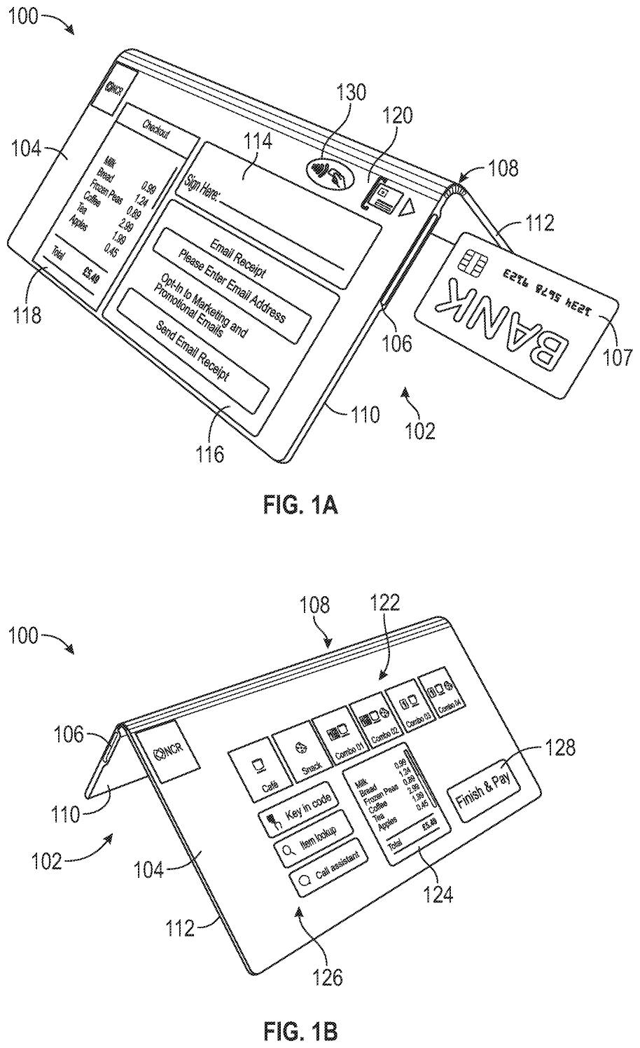

Turning now to the figures, FIGS. 1A-1D show an example POS device 100 consistent with embodiments disclosed herein. POS device 100 may include a body 102 and a display screen 104. The body may define a first port 106. First port 106 may be used to accept a credit/debit card 107 and may include a chip reader to read EMV chips, etc. As such, first port 106 may allow POS device 100 to accept cards as a form of payment.

As disclosed herein, POS device 100 may also allow for contactless payments. For example, as disclosed herein, POS device 100 may include BLUETOOTH® modules, NFC modules, WI-FI® modules, etc. As a result, a customer may be able to pay for goods and services using POS device 100 and his or her mobile device. For example, during a touchless transaction the customer may place his or her phone or watch next to an NFC icon 130 to complete the transaction.

As shown in FIGS. 1A-1D, body 102 may include a hinge 108. Hinge 108 may be located in between a first portion 110 and a second portion 112 of body 102. Hinge 108 may be formed by one or more indentations in material forming body 102 and display 104. The indentations may form one or more voids that allow portions of body 102 and display 104 to flex.

Hinge 108 may also be formed of a material that is naturally flexible. For example, first portion 110 and second portion 112 may be formed of a ridged plastic or metal and hinge 108 may be formed of a flexible plastic, rubber, engineered metal mechanisms, etc.

Display 104 may be attached to body 102. Display 104 may be a glass, plastic, etc. For example, display 104 may be a continuous piece of glass that covers a surface of first portion 110 and second portion 112 and extends across or spans hinge 108. A such, display 104 may be a seamless article that may be capable of displaying a single user interface across POS device 100 or multiple portions of a user interface displayed on POS device 100.

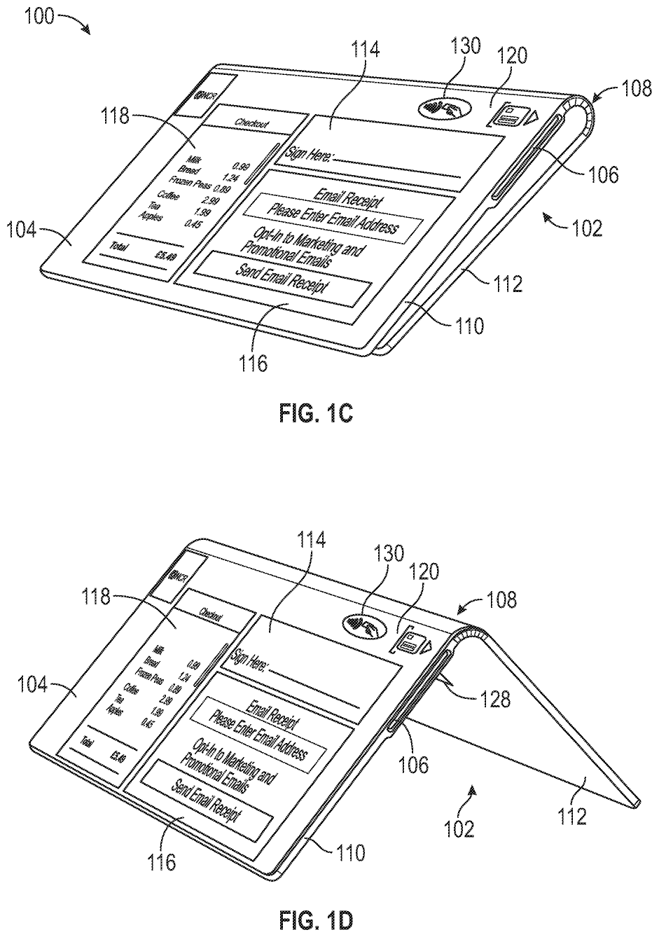

As shown in FIGS. 1A-1D, POS display 100 may be folded at an angle. The angle may range from 0 degrees as shown in FIG. 2A to about 180 degrees as shown in FIG. 1C or any angle in between as shown in FIGS. 1A, 1B, and 1D.

The user interface may be configured so that a first portion may be displayed on a portion of display 104 that is connected to first portion 110 of body 102 and a second portion of the user interface may be displayed on a second portion of display 104 that is connected to second portion 112 of body 102. The first portion of the user interface may be presented to the user. For example, as shown in FIG. 1A, the first portion of the user interface may include a place for the user to sign for purchases 114, enter an email address to receive an email copy of a receipt 116, as well as a listing of items being purchased 118. The first portion of the user interface may also provide an icon 120 to indicated when a user is to insert his or her card into port 106.

As shown in FIG. 1B, the second portion of the user interface may be presented to a cashier and may include menu items 122 for items the customer may purchase, a copy of items purchased 124, buttons 126 for functions a cashier may need, and a button 128 to complete the transaction.

Turning now to FIGS. 2A and 2B, FIGS. 2A and 2B show an example POS device 200 consistent with embodiments disclosed herein. POS device 200 may include all of the features described above with respect to POS device 100. FIGS. 2A and 2B may simply show POS device 100 in a different configuration.

POS device 200 may include a body 202 and a display 204 that is connected to body 202. Just as with POS device 100, display 204 may be laminated to body 202 to form a laminated structure.

As shown in FIG. 2A, POS device 200 may display a user interface 206 that extends across a hinge 208. POS device 200 may be configured for a self-checkout mode of operation. As such, POS device 208 may be hung on a post or other fixture within a store in a vertical orientation as shown herein. For example, a first portion 210 of body 202 may be attached to a wall. During use, a user may reposition a second portion 212 of body 202 at an angle as shown in FIG. 2B. By angling second portion 212, the information displayed on second portion 212 may be easier for a user to view.

Just as with POS device 100, POS device 200 may include a port 214 for receiving a card and may include an icon 216 to indicate when a user is to insert his or her card. User interface 206 may also include a place for the user to sign for purchases 218, enter an email address to receive an email copy of a receipt 220, as well as a listing of items being purchased 222.

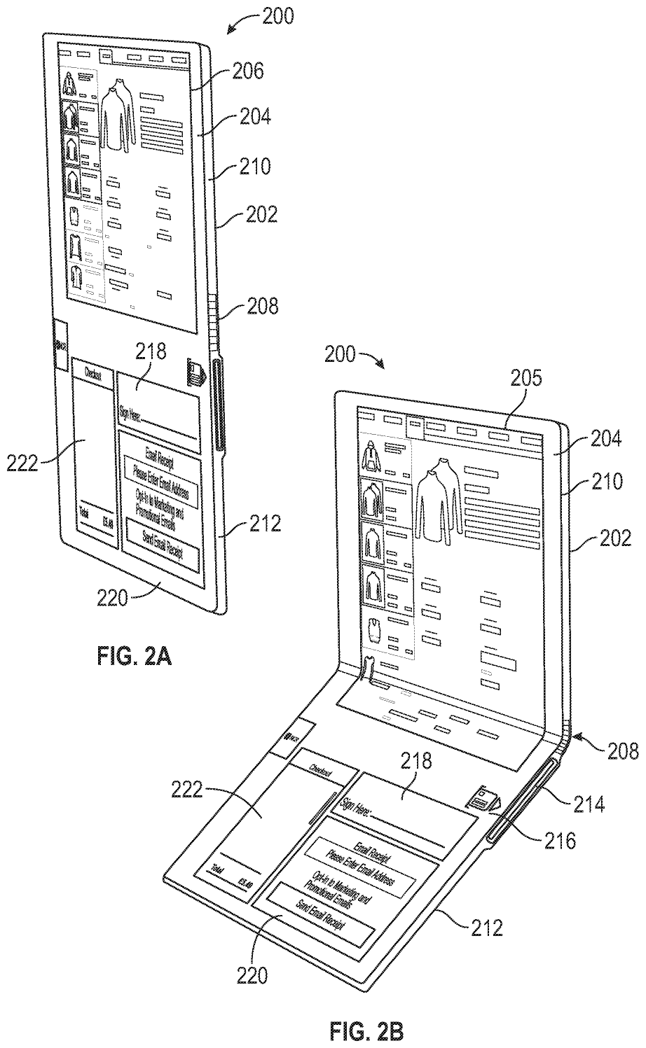

FIGS. 3A and 3B show an example POS device 300, such as POS device 100 or POS device 200, consistent with embodiments disclosed herein. POS device 300 may dock to a docking station 302. Docking station 302 may include a port 304 that may connect to a port 128 (see FIG. 1D). Using docking station 302 may allow for POS device 300 to be charged, provide power to operate POS device 300 during charging or if POS device 300 does not have a battery, etc.

Port 304 may also be an input/output (I/O) port. Thus, port 304 may allow POS device 300 to connect to other devices such as, but not limited to, printers, scales, scanners, etc. Port 300 may also act as a communications port to allow POS device 300 to send and receive signals and information. Fore example, using port 304, POS device 300 may transmit sales data to a server or some other remove device.

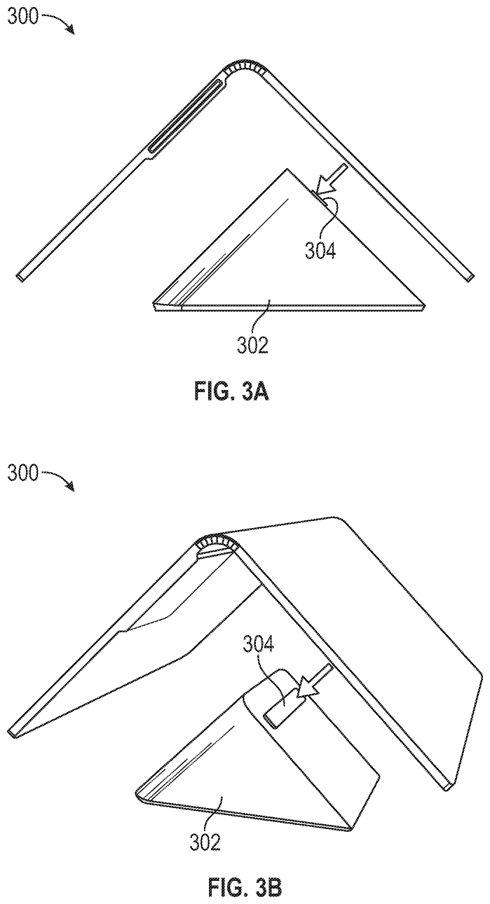

Turning now to FIG. 4, FIG. 4 shows an example schematic of a POS device 400 consistent with embodiments disclosed herein. POS device 400 may include any POS device disclosed herein such as POS device 100, 200, or 300. As shown in FIG. 4, POS device 400 may include a processor 402 and a memory 404. As disclosed herein, processor 402 and memory 404 may be located in a cavity defined by a body of a POS device.

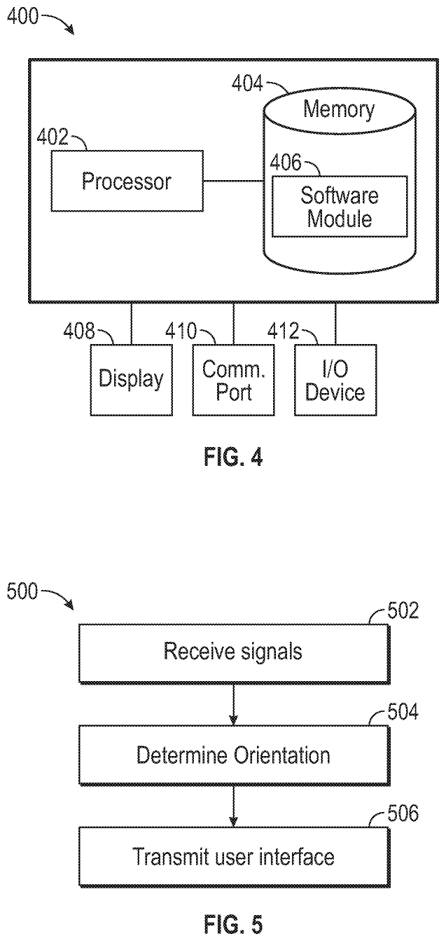

Memory 204 may include a software module 406. While executing on processor 402, software module 406 may perform processes for adjusting the user interface displayed on POS device 400, including, for example, one or more stages included in method 500 described below with respect to FIG. 5.

POS device 400 may include a display 408. Display 408 may include a single piece of flexible glass as disclosed herein. As disclosed herein, display 408 may be laminated to a body of POS device 400 and may allow for one or more user interfaces to be displayed to one or more users. The user interfaces may include one or more portions as disclosed herein for displaying various data, input boxes, etc.

POS device 400 may also include a communications port 410. Communications port 410 may allow POS device 400 to communicate with various information sources and devices, such as, but not limited to, remote computing devices, mobile devices, peripheral devices, cameras, etc. Non-limiting examples of communications port 410 include, Ethernet cards (wireless or wired), Bluetooth® transmitters and receivers, near-field communications modules, etc.

POS device 400 may also include an I/O device 412. I/O device 412 may allow POS device 400 to receive and output information. Non-limiting examples of I/O device 412 include, accelerometers, cameras, a weight detection device such as a scale, a printer for printing receipts, and packing lists, etc. I/O device 412 may also utilize communications port 410 to communicate with other devices. An example of I/O device 412 and/or communications port 410 may include port 128 as disclosed above.

FIG. 5 shows an example method 500 for using a flexible POS device, such as POS devices 100, 200, 300, or 400, as disclosed herein. As disclosed herein the flexible POS device may be used in a variety of environments ranging from an individual operating a small business to a large multichain business operating multiple brick and mortar stores. In each of the different environments, the POS device may be oriented in different ways. For example, in a store or a booth at a craft fair, etc. the POS device may be folded so that half of the display of the POS device faces a customer and the other half of the POS device faces a cashier. For instance, at the start of the day or the start of a transaction, the cashier may fold the POS device as shown in FIGS. 1A-1D. As a standalone self-checkout terminal in a store, the POS device may be configured as shown in FIGS. 2A and 2B.

Once the POS device is in position and powered up, the processor inside the POS device may receive signals from accelerometers inside various portions of the POS device (502). The signals may be used to determine the orientation of each part of the POS device (504). For example, the POS device may have two ridged portions that are connected by a flexible/hinged portion. The two ridged portions may be arranged in different orientation. Using the signals from the accelerometers, the processor may determine the orientation of the two ridged portions of the POS device with respect to each other. In addition, using the signals form the accelerometers, the processor may determine the orientation of the POS device with respect to an external coordinate system. For example, using the signals from the accelerometers may determine that a first portion of the POS device is in a vertical orientation and a second portion of the POS device is angled relative to the first portion as shown in FIG. 2B.

Once the orientations of the various portions of the POS device are determined, one or more user interfaces may be transmitted to the screen of the POS device (506). For example, a single user interface and various portions of the single user interface may be transmitted to various portions of the display of the POS device. FIGS. 2A and 2B shown an example of a single user interface that includes multiple portions.

Transmitting the user interfaces may include transmitting multiple user interfaces to a user. For example, FIGS. 1A-1D show a configuration where there are two users of the POS device, a customer and a cashier. Each of the user may have a separate interface, such as a customer interface and a cashier interface. As such, transmitting the interface to the display may include transmitting the customer interface to a first portion of the display of the POS device and transmitting a cashier interface to a second portion of the display of the POS device.

The accelerometer may continuously transmit signals to the processor and the processor may continuously determine an orientation of the POS device or portions of the POS device. As such, during use when the POS device is reoriented or a new operation is performed, the processor may cause the one or more user interfaces to rotate and/or be replaced with new/updated interfaces depending on the orientation and/or operations be being performed by the POS device.

### Examples

Example 1 is a flexible point of sale device comprising: a body having a first ridged portion, a second ridged portion, and a flexible portion located in between the first ridged portion and the second ridged portion; and a flexible display screen connected to the body, the flexible display screen spanning the first ridged portion, the flexible portion, and the second ridged portion.

In Example 2, the subject matter of Example 1 optionally includes wherein the flexible portion of the body and the display screen each includes a living hinge.

In Example 3, the subject matter of any one or more of Examples 1-2 optionally include wherein the flexible display screen is glass.

In Example 4, the subject matter of any one or more of Examples 1-3 optionally include wherein the flexible portion of the body and the flexible display screen each are bendable from about 0 degrees to about 180 degrees.

In Example 5, the subject matter of any one or more of Examples 1-4 optionally include wherein the flexible display screen is a touchscreen.

In Example 6, the subject matter of any one or more of Examples 1-5 optionally include wherein the flexible display screen is laminated to the body.

Example 7 is a flexible point of sale display comprising: a body having a first ridged portion, a second ridged portion, and a flexible portion located in between the first ridged portion and the second ridged portion; and a flexible display screen connected to the first ridged portion and the second ridged portion, the flexible display screen spanning the flexible portion to provide a continuous display, wherein surfaces of the body connected to the flexible display define a plane when the body is in a flat state.

In Example 8, the subject matter of Example 7 optionally includes wherein the flexible display screen is glass.

In Example 9, the subject matter of any one or more of Examples 7-8 optionally include wherein the flexible display screen is a touchscreen.

In Example 10, the subject matter of any one or more of Examples 7-9 optionally include wherein the flexible display screen and the body form a laminated structure.

In Example 11, the subject matter of any one or more of Examples 7-10 optionally include wherein the flexible portion of the body and the flexible display screen each are bendable from about 0 degrees to about 180 degrees.

In Example 12, the subject matter of any one or more of Examples 7-11 optionally include wherein the body defines a cavity sized to house one or more electronic items.

In Example 13, the subject matter of any one or more of Examples 7-12 optionally include wherein the body defines one or more ports sized to receive a credit card.

In Example 14, the subject matter of any one or more of Examples 7-13 optionally include wherein the flexible point of sale display is hermetically sealed.

Example 15 is a flexible point of sale display comprising: a body comprising a first ridged portion defining a first cavity, a second ridged portion defining a second cavity, and a flexible portion located in between the first ridged portion and the second ridged portion; first and second accelerometers located in the first and second cavities, respectively; a flexible display screen laminated to and spanning a surface defined by the first ridged portion, the second ridged portion, and the flexible portion; a processor located within the first cavity or the second cavity and electrically coupled to the flexible display screen, the first accelerometer, and the second accelerometer; and a memory located in the cavity and electrically coupled to the processor, the memory storing instructions that, when executed by the processor, cause the processor to perform actions comprising: receiving signals from the first and second accelerometers, determining an orientation of the first ridged portion and the second ridged portion using the signals, transmitting a first user interface to a first portion of the flexible display attached to the first ridged portion, the first user interface oriented for use by a user of the first user interface, and transmitting a second user interface to a second portion of the flexible display attached to the second ridged portion, the second user interface oriented for use by a user of the second user interface.

In Example 16, the subject matter of Example 15 optionally includes wherein determining the orientation of the first ridged portion and the second ridged portion includes determining that the first ridged portion and the second ridged portion are angled relative to one another.

In Example 17, the subject matter of any one or more of Examples 15-16 optionally include wherein determining the orientation of the first ridged portion and the second ridged portion includes determining that the first ridged portion is in a vertical orientation and the second ridged portion is angled relative to the first ridged portion.

In Example 18, the subject matter of any one or more of Examples 15-17 optionally include wherein transmitting the first user interface and the second user interface include transmitting a single user interface, the first user interface being a first portion of the single user interface and the second user interface being a second portion of the user interface.

In Example 19, the subject matter of any one or more of Examples 15-18 optionally include wherein the body defines one or more ports sized to receive a credit card.

In Example 20, the subject matter of any one or more of Examples 15-19 optionally include a docking station, the body defining a port for accepting a corresponding port of the flexible point of sale display.

In Example 21, the systems, self-service terminals, or methods of any one of or any combination of Examples 1-20 are optionally configured such that all elements or options recited are available to use or select from.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A flexible point of sale device comprising:
a body having a first ridged portion, a second ridged portion, and a flexible portion located in between the first ridged portion and the second ridged portion, the flexible portion forming a hinge formed by one or more indentations in a material forming the body;
a flexible display screen connected to the body, the flexible display screen spanning the first ridged portion, the flexible portion, and the second ridged portion; and
an accelerometer configured disable a portion of the flexible display spanning the second ridged portion upon the portion oriented in a downward direction.

2. The flexible point of sale device of claim 1, wherein the display screen includes a living hinge.

3. The flexible point of sale device of claim 1, wherein the flexible display screen is glass.

4. The flexible point of sale device of claim 1, wherein the flexible portion of the body and the flexible display screen each are bendable from about 0 degrees to about 180 degrees.

5. The flexible point of sale device of claim 1, wherein the flexible display screen is a touchscreen.

6. The flexible point of sale device of claim 1, wherein the flexible display screen is laminated to the body.

7. A flexible point of sale device comprising:
a body having a first ridged portion, a second ridged portion, and a flexible portion located in between the first ridged portion and the second ridged portion, the flexible portion forming a hinge formed by one or more indentations in a material forming the body;
a flexible display screen connected to the first ridged portion and the second ridged portion, the flexible display screen spanning the flexible portion to provide a continuous display; and
an accelerometer configured disable a portion of the flexible display spanning the second ridged portion upon the portion oriented in a downward direction,
wherein surfaces of the body connected to the flexible display define a plane when the body is in a flat state.

8. The flexible point of sale device of claim 7, wherein the flexible display screen is glass.

9. The flexible point of sale device of claim 7, wherein the flexible display screen is a touchscreen.

10. The flexible point of sale device of claim 7, wherein the flexible display screen and the body form a laminated structure.

11. The flexible point of sale device of claim 7, wherein the flexible portion of the body and the flexible display screen each are bendable from about 0 degrees to about 180 degrees.

12. The flexible point of sale device of claim 7, wherein the body defines a cavity sized to house one or more electronic items.

13. The flexible point of sale device of claim 7, wherein the body defines one or more ports sized to receive a credit card.

14. The flexible point of sale device of claim 7, wherein the flexible point of sale display is hermetically sealed.

15. A flexible point of sale device comprising:
a body comprising a first ridged portion defining a first cavity, a second ridged portion defining a second cavity, and a flexible portion located in between the first ridged portion and the second ridged portion;
first and second accelerometers located in the first and second cavities, respectively;
a flexible display screen laminated to and spanning a surface defined by the first ridged portion, the second ridged portion, and the flexible portion;
a processor located within the first cavity or the second cavity and electrically coupled to the flexible display screen, the first accelerometer, and the second accelerometer; and
a memory located in the cavity and electrically coupled to the processor, the memory storing instructions that, when executed by the processor, cause the processor to perform actions comprising:
receiving signals from the first and second accelerometers,
determining an orientation of the first ridged portion and the second ridged portion using the signals,
transmitting a first user interface to a first portion of the flexible display attached to the first ridged portion, the first user interface oriented for use by a user of the first user interface, and
transmitting a second user interface to a second portion of the flexible display attached to the second ridged portion, the second user interface oriented for use by a user of the second user interface.

16. The flexible point of sale device of claim 15, wherein determining the orientation of the first ridged portion and the second ridged portion includes determining that the first ridged portion and the second ridged portion are angled relative to one another.

17. The flexible point of sale device of claim 15, wherein determining the orientation of the first ridged portion and the second ridged portion includes determining that the first ridged portion is in a vertical orientation and the second ridged portion is angled relative to the first ridged portion.

18. The flexible point of sale device of claim 15, wherein transmitting the first user interface and the second user interface include transmitting a single user interface, the first user interface being a first portion of the single user interface and the second user interface being a second portion of the user interface.

19. The flexible point of sale device of claim 15, wherein the body defines one or more ports sized to receive a credit card.

20. The flexible point of sale device of claim 15, further comprising a docking station, the body defining a port for accepting a corresponding port of the flexible point of sale display.
